(19) United States
(12) Patent Application Publication
(10) Pub. No.: US 2015/0091831 A1
(43) Pub. Date: Apr. 2, 2015

(54) DISPLAY DEVICE AND DISPLAY CONTROL METHOD

(71) Applicant: Panasonic Corporation, Osaka (JP)

(72) Inventors: Kiyoshi NAKANISHI, Osaka (JP); Shunichi KUROMARU, Osaka (JP); Tomoo KIMURA, Fukuoka (JP); Hiromichi NISHIYAMA, Osaka (JP)

(21) Appl. No.: 14/494,599

(22) Filed: Sep. 24, 2014

(30) Foreign Application Priority Data
Sep. 27, 2013 (JP) 2013-201527
Sep. 11, 2014 (JP) 2014-185225

(51) Int. Cl. G06F 3/041

(52) U.S. Cl. CPC G06F 3/041
USPC 345/173

(57) ABSTRACT

The display device including a touch panel comprises a display unit having a screen that displays information according to a touch operation, and a controller that detects a plurality of contact positions on the screen according to the touch operation and controls the display unit to display first selection information at a position spaced from the plurality of contact positions by a predetermined distance. When at least one contact position of the plurality of contact positions is moved in the screen, the display unit moves and displays the first selection information on the screen to and at a position spaced from the moved contact position by the predetermined distance. The display device with a touch panel is easy for a user to operate by touching.

### PRIORITY

This application claims priority to Japanese Patent Application No. 2013-201527 filed on Sep. 27, 2013 and Japanese Patent Application No. 2014-185225 filed on Sep. 11, 2014. The entire disclosure of Japanese Patent Application 2013-201527 and Japanese Patent Application No. 2014-185225 are hereby incorporated herein by reference.

### BACKGROUND

### TECHNICAL FIELD

This disclosure relates to a display device with a touch panel and a display control method.

### BACKGROUND ART

Display devices with a touch panel have been commonly known. With the display devices, users can enter characters or draw figures on a touch panel using a pointing device including an electronic pen and a mouse, and select icons or windows on the touch panel by a touch operation.

One known example is a display device that controls its display by sensing how widely a user opens his/her hand or fingers during the user operates the display device by touching (see, for example, Japanese Unexamined Patent Application Publication No. 2011-003074). The display device obtains lines connecting contact points of fingers on the screen, calculates an area of a polygonal region defined by the detected points and lines, and changes its display switching rate depending on the calculated area size.

### SUMMARY

### Technical Problem

As display devices with a touch panel have become popular, they are required to improve their touch operability.

This disclosure aims to improve a touch operability of a display deice with a touch panel.

### Solution to Problem

The display device as disclosed here is a display device with a touch panel comprising a display unit and a controller. The display unit includes a screen that displays information according to a touch operation. The controller detects a plurality of contact positions on the screen of the display unit that are made by the touch operation, and controls the display unit based on the detection result. The display unit displays first selection information on the screen at a position spaced from the plurality of contact positions by a predetermined distance. When at least one contact position of the plurality of contact positions is moved in the screen, the display unit moves and displays the first selection information to and at a position spaced from the moved contact position by the predetermined distance.

The display control method as disclosed here is a display control method performed by a display device with a touch panel, including detecting a plurality of contact positions on a screen of the display device that are made by a touch operation, displaying first selection information on the screen at a position spaced from the plurality of contact positions by a predetermined distance, and when at least one contact position of the plurality of contact positions is moved in the screen, moving and displaying the first selection information to and at a position spaced from the moved contact position by the predetermined distance.

This disclosure is useful in improving a touch operability of a display device with a touch panel.

### BRIEF DESCRIPTION OF THE DRAWINGS

FIG. 1 shows an appearance of a tablet computer;

FIG. 2 shows a cross section of a display panel of the tablet computer;

FIG. 3 shows a schematic configuration of the tablet computer;

FIG. 4 shows a flow chart of a menu display operation according to Embodiment 1;

FIGS. 5A to 5C show an example of a displayed menu according to Embodiment 1;

FIG. 6 shows a flowchart of a menu display operation according to Embodiment 2;

FIG. 7 shows a flowchart of a menu display operation according to Embodiment 2;

FIG. 8 shows an example of a touch operation according to Embodiment 2;

FIGS. 9A to 9E illustrate measurement of distances between contact positions, performed by a controller according to Embodiment 2;

FIG. 10 illustrates measurement of a size and position of a hand, performed by the controller according to Embodiment 2;

FIG. 11 shows an example of a displayed menu according to Embodiment 2;

FIGS. 12A and 12B illustrate correction of a menu display position according to Embodiment 2;

FIG. 13 shows a modified example of a displayed menu according to Embodiment 2;

FIG. 14 shows a flowchart of a menu display operation according to the modified example;

FIG. 15 shows an example of a displayed menu according to another embodiment; and

FIG. 16 shows an example of a displayed menu according to still another embodiment.

### DETAILED DESCRIPTION

Embodiments will now be described with reference to the drawings. Excessive details may be omitted. To avoid redundancy and help easy understanding for those skilled in the art, features known in the art may not be described in detail and substantially the same components may not be described in duplicate.

The attached drawings and description provided by the inventors are intended for those skilled in the art to fully understand the disclosure, and shall not limit the subject matter claimed.

The display device according to embodiments as described later displays menus on a screen when a user touches the screen. The menu position is in the vicinity of the user hand on the screen where the user can see the menus easily. With the display device, the user can draw intricate figures including design drawings by using a pointing device such as an electronic pen in one hand and touching the screen with the other hand to select a displayed menu on the screen.

This disclosure takes a tablet computer as an example of a display device. The tablet computer according to the embodiments is installed with a CAD (Computer aided design system) system, which displays and modifies, for example, design drawings on the computer.

### Embodiment 1

1-1. Configuration

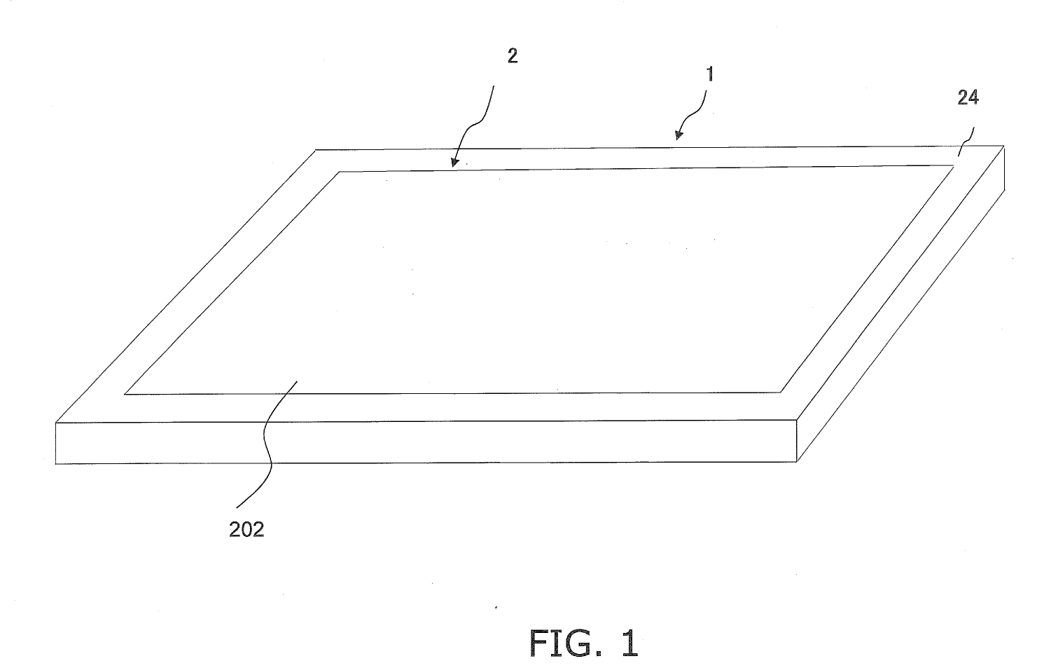

FIG. 1 shows a configuration of a tablet computer 1 (an example of a display device) according to this embodiment. The tablet computer 1 comprises a display panel 2 (an example of a display unit) and a control device 3 connected to the display panel 2, which will be discussed later.

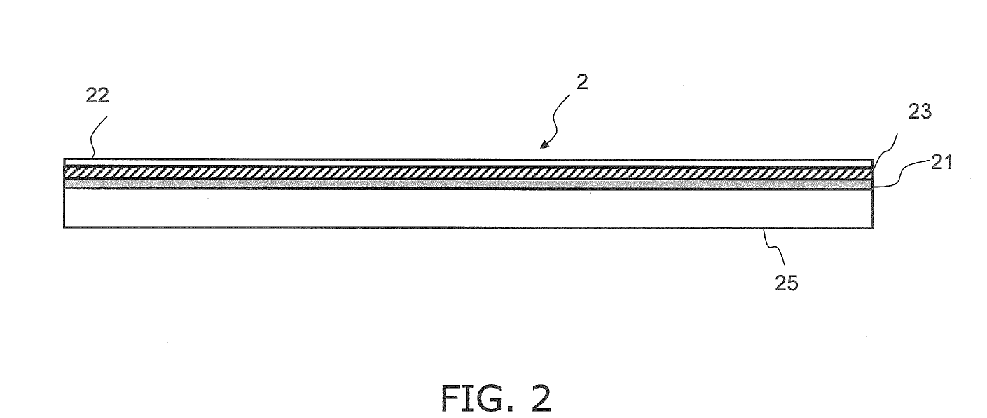

FIG. 2 is a cross section of the display panel 2. As shown in FIG. 1 and

FIG. 2, the display panel 2 is composed by a digitizer 21, touch panel 23, and liquid crystal panel 25 laminated and unified in a frame 24 (FIG. 1).

The digitizer 21 detects tracks of a pen handled by a user and outputs original information for a coordinate to a pen operation detection circuit 31, as discussed later.

The touch panel 23 is touched by a user. The touch panel 23 has a wide area enough to cover a touching region and is arranged over the liquid crystal panel 25 in an overlapping manner. The touch panel 23 comprises a cover 22 (FIG. 2) formed by an insulating film layer made from glass or plastic, an electrode layer, and a base layer, in that order starting from a side that the user operates. The electrode layer includes transparent electrodes arranged in a matrix having an X-axis (a horizontal axis, for example) and a Y-axis (a vertical axis, for example). The electrode layer obtains coordinate information for contact positions, as discussed later. The electrodes may be less dense than or substantially as dense as pixels of the liquid crystal panel 25. The former is applied to this embodiment. The touch panel 23 may be capacitive, resistive, optical, or may be a type using ultrasonic wave or electro magnetic resonance.

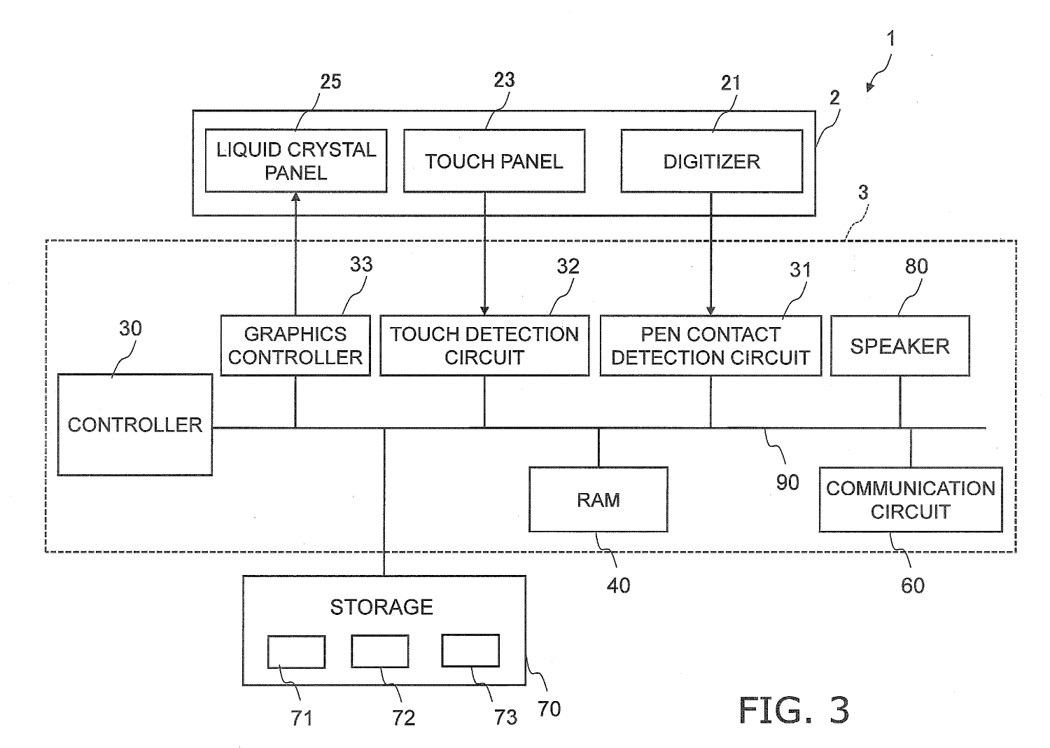

The crystal liquid panel 25 provides a screen 201 that displays images based on image data processed by a graphics controller 33 (FIG. 3), as discussed later. The crystal liquid panel 25 displays text data including characters and numbers, and graphic data. Particularly, this embodiment describes the liquid crystal panel 25 as a device that displays architectural design data, for example. The screen 201 of the crystal liquid panel 25 according to the embodiment is a 20-inch screen with an image resolution of 3,840×560 dots, for example. The crystal liquid panel 15 may be substituted with an organic Electro-Luminescence (OEL) panel, an electronic paper, or a plasma panel. The liquid crystal panel 25 may include a power circuit, a drive circuit, and a light source depending on the type of a display panel.

The frame 24 accommodates the display panel 2 including the touch panel 23, digitizer 21 and crystal liquid panel 25, and the control device 3 as discussed later. Though not shown in FIG. 1, the frame 24 may include a power button and/or a speaker.

The user touches the screen 201 of the display panel 2 with his/her fingers to perform a touch operation. The user may make a tracing on the screen 201 with the electronic pen 5 to draw figures.

Although the touch panel 23 and the crystal liquid panel 25 are separate in this embodiment, they may be integrally formed. As shown in FIG. 3 discussed later, the display panel 2 includes functions of both the touch panel 23 and the crystal liquid panel 25.

In this embodiment, the user touches the screen 201 of the display panel 2 with his/her fingers to perform a touch operation. The touch operation may be performed using a stylus as a pointing device.

FIG. 3 schematically shows an internal configuration of the tablet computer 1.

The tablet computer 1 comprises the above-described display panel 2 and the control device 3. The control device 3 includes the controller 30 (an example of a controller), pen touch detection circuit 31, touch operation detection circuit 32, graphics controller 33, RAM 40, communication circuit 60, speaker 80, and bus 90.

The pen touch detection circuit 31 converts a coordinate of input information from the digitizer 21 and outputs the information with the converted coordinate to the controller 30.

The touch operation detection circuit 32 detects a touch operation of the user through the touch panel 23 using a projected capacitive touch technology, for example. The touch operation detection circuit 32 scans the matrix with an X-axis and a Y-axis in a sequential manner. When the touch operation detection circuit 32 has detected a touch by detecting a change in the electric capacity, it produces coordinate information with a density (resolution) equal to or greater than that of the pixels of the liquid crystal panel 25. The touch operation detection circuit 32, which is capable of detecting touches at plural positions at the same time, successively outputs a series of coordinate data that have been obtained upon detection of touch operations. The coordinate data are input to the controller 30, which will be discussed later, and determined as various touch operations including tapping, dragging, flicking, and swiping.

As commonly known, an operating system running the tablet computer 1 detects touch operations.

The controller 30 is formed by a processing circuit (for example, a CPU) that executes various processes, which will be discussed later, using the information detected by the pen operation detection circuit 31 and touch information detected by the touch operation detection circuit 32. The controller 30 executes a display control program in a specific application such as a CAD application.

The graphics controller 33 operates based on control signals produced by the controller 30. The graphics controller 33 produces image data including menu images to be displayed on the liquid crystal panel 25. The image data are displayed on the screen 201.

RAM 40 is a working memory. A display control program in the application for running the tablet computer 1 is stored in RAM 40 while it is executed by the controller 30.

The communication circuit 60 performs communications with the Internet or other personal computers, for example. The communication circuit 60 performs wireless communication according to, for example, Wi-Fi or Bluetooth (registered trademark). The communication circuit 60 also communicates with an input means including an electronic pen and a mouse.

The speaker 80 outputs sounds based on sound signals produced by the controller 30.

The bus 90 is a signal line that connects components of the device with each other, except for the display panel 2, such that signals are sent and received by the components.

The control device 3 is also connected to the storage 70, as shown in FIG. 3. The storage 70 is a flash memory, for example. The storage 70 stores image data 71 to be displayed, the display control program 72 in a CAD application, for example, and touch information 73 as will be discussed later. In this embodiment, the image data 71 may include static image data and/or three-dimensional image data.

1-2. Operation

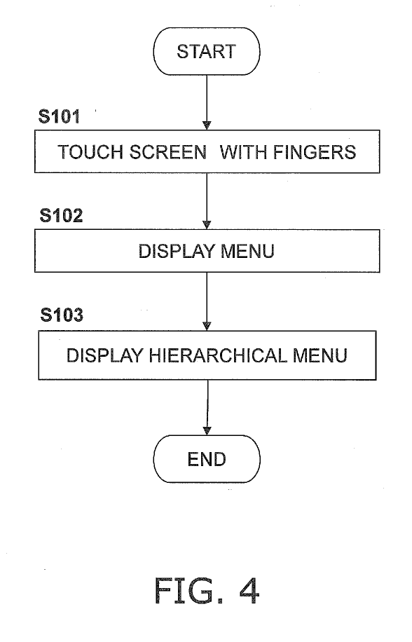

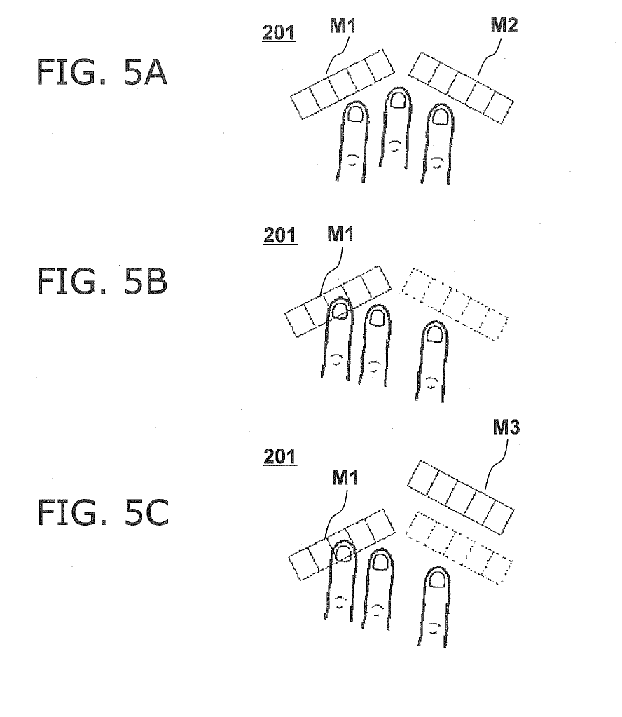

The following is the operation for displaying menus on the screen 201 of the display panel 2 in response to the touch operation by a user, which will be discussed with reference to FIG. 4 and FIG. 5. FIG. 4 shows a flow chart of an operation for displaying menus. FIG. 5 shows an example of the menus as displayed.

Step S101: When the user touches the touch panel 23 with his/her fingers of one hand (left hand in the drawing), the touch operation detection circuit 32 detects the touches. The controller 30 then obtains positions of the detected touches, or calculates coordinates of the contact positions.

Step S102: The controller 30 displays menus (an example of first selection information) on the screen 201 at positions spaced from the calculated contact positions by the predetermined distance. The menus are positioned on the screen based on coordinate positions of an annular finger and an index finger. For example, as shown in FIG. 5A, menus M1, M2 including identical contents are positioned on the screen so as not to be under the annular and index fingers, or positioned above the annular and index fingers. With the menus thus displayed, the user can select one of the menus with either one of the annular or index finger.

Even when the user has moved his/her finger on the screen 201, the menus will be positioned on the screen so as not to be under the moved fingers, or positioned above the moved fingers, based on the coordinate positions of the moved fingers.

Then, as shown in FIG. 5B, when the user selects an item of the displayed menu M1 with his/her annular finger, for example, the controller 30 commands the display panel 2 to stop displaying the menu M2 near the user's index finger on the screen 201. If the user selects an item of the displayed menu M2 with his/her index finger, the controller 30 then commands the display panel 2 to stop displaying the menu M1 near the user's annular finger on the screen 201.

Step S103: The controller 30 commands the display panel 2 to display the menu M3 (an example of second selection information) that is a subsequent menu to the menu M1 selected with the annular finger in step S104. For example, as shown in FIG. 5C, the menu M3 is subsequently displayed at a position above the index finger. The menu M3 includes items that differ depending on the selected item in the menu M1.

Then, the controller 30 commands the display panel 2 to stop displaying the menu M1 near the ring finger on the screen 201. Since the menu M1 is selected with one of the fingers on the screen and the subsequent menu M3 is then displayed above another one of the fingers, the user can select the menus without difficulty in moving his/her fingers.

In this embodiment, menus are displayed near the user's annular and index fingers on the screen 201, but this is not the only option. Two fingers other than the combination of annular and index fingers may be used.

The displayed menus may be curved along the fingers such that each menu item is substantially equally spaced from each finger on the screen 201.

1-3. Effects, etc.

The tablet computer 1 (an example of a display device) according to this embodiment comprises a display panel 2 (an example of a display unit) including a screen 201 that displays information according to a touch operation, and a controller 30 (an example of a controller) that detects a plurality of contact positions on the screen 201 made by the touch operation and that displays a menu (an example of first selection information) on the screen 201 of the display panel 2 at a position spaced from the plurality of contact positions by a predetermined distance. When at least one contact position of the plurality of contact positions on the screen 201 is moved, the display panel 2 moves and displays the first selection information to and at a position spaced from the moved contact position by the predetermined distance.

The known techniques aimed to measure a size and an angle of a hand rather than detecting a hand itself. Therefore, the known techniques did not locate each finger of a hand but only obtained a position of a polygon defined by connecting contact positions of fingers on a screen (see, for example, Japanese Unexamined Patent Application Publication No. 2011-003074). For example, when displaying a GUI (Graphical User Interface) around a hand on a screen, the known techniques could not produce a display interface easy for a user to use. This is because such techniques could only determine a size of a user's hand but could not obtain finger positions of the hand or determine whether the hand is right or left.

The tablet computer 1 according to this embodiment displays a menu on the screen 201 at a position spaced from and above a contact position of each finger by the predetermined distance. Therefore, the display interface is easy to manipulate.

In the tablet computer 1 according to this embodiment, when an item of the first menu has been selected, the display panel 2 displays the second menu that is different depending on the selected item of the first menu. Since the user need use only one hand to cause the menu to be displayed in a hierarchical manner, a display interface with a good operability can be obtained.

### Embodiment 2

The tablet computer according to Embodiment 2 will be described below. This embodiment includes determining the position of a hand contacting a screen, such as each finger's position, a thumb location, the hand's angle and center, as well as determining the hand's size and whether the hand is right or left, based on which a position for displaying menus on the screen is determined. Accordingly, the menus can be displayed at such positions that are easy for a user to touch and see, and therefore, the touch panel can be easier to be handled.

2-1. Configuration

The tablet computer (an example of a display device) according to this embodiment has a similar configuration as the tablet computer 1 as shown in FIGS. 1 to 3 according to Embodiment 1, and therefore, the detailed description thereof will be omitted here. These figures and their reference numerals will be referred to where appropriate.

2-2. Operation

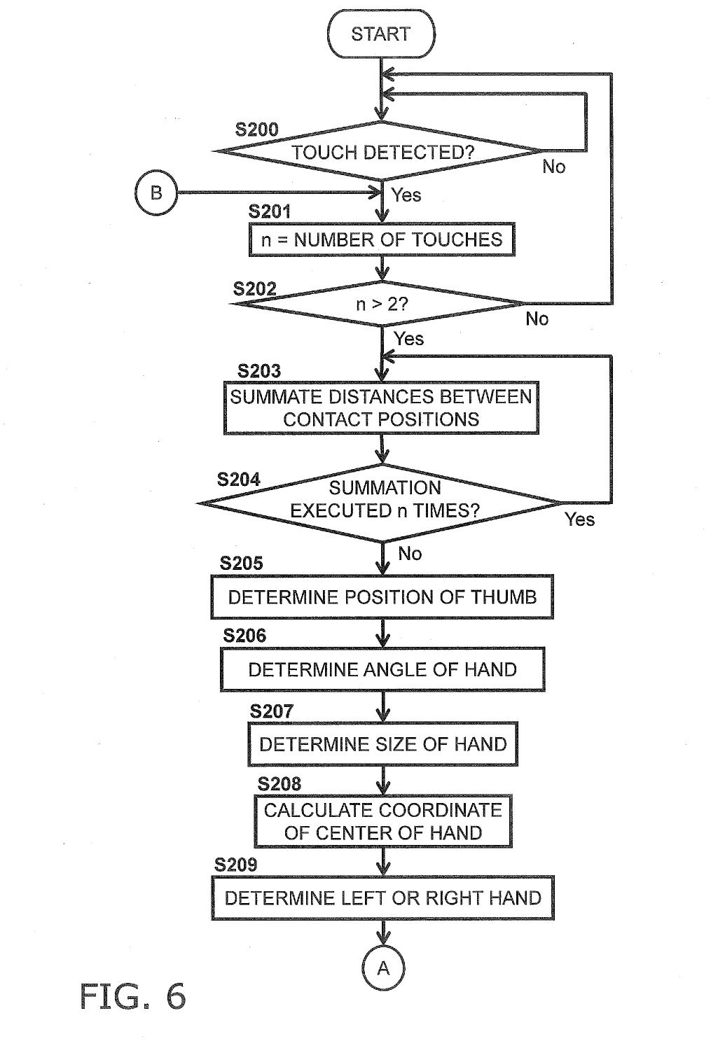

The operation for displaying menus mainly by the control device 3 shown in FIG. 3 will be discussed with reference to FIG. 6 to FIGS. 12 below.

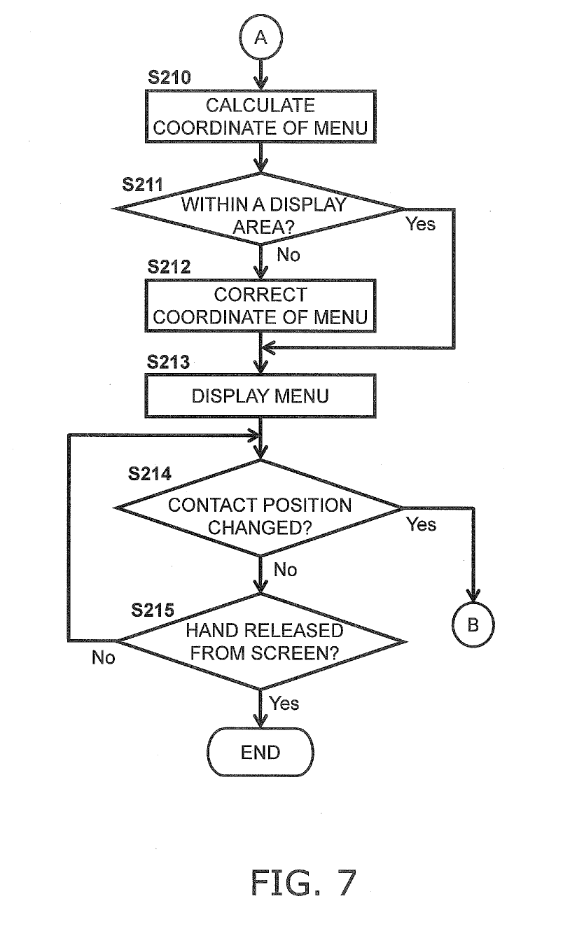

The controller 30 of the control device 3 in the tablet computer 1 according to Embodiment 1 detects the position and size of a hand on the screen 201, determines whether the hand is left or right, and based on this information, determines the menu display positions on the screen 201. The operation for these will be explained with the flowchart shown in FIG. 6 and FIG. 7.

S200: The controller 30 detects whether the screen has been touched. Particularly, the controller 30 determines whether the touch operation detection circuit 32 has detected a touch operation.

The controller 30 calculates the detected contact positions or the coordinate values for all the touching fingers, and stores these data in the storage 70 as touch information 73.

S201: The controller 30 counts the detected contact positions as number n, concurrently with step S200.

S202: If the detected contact positions are more than two, or three or more, the controller 30 proceeds to step S203 to pursue the process. If the detected contact positions are two or less, the controller 30 returns to step S200 and waits for a next touch.

In this embodiment, the position of a hand can be detected with at least three contact positions. The following example, however, illustrates a left hand 301 on the screen 201 of the display panel 2 with all five touching fingers at five contact positions T1, T2, T3, T4, and T5.

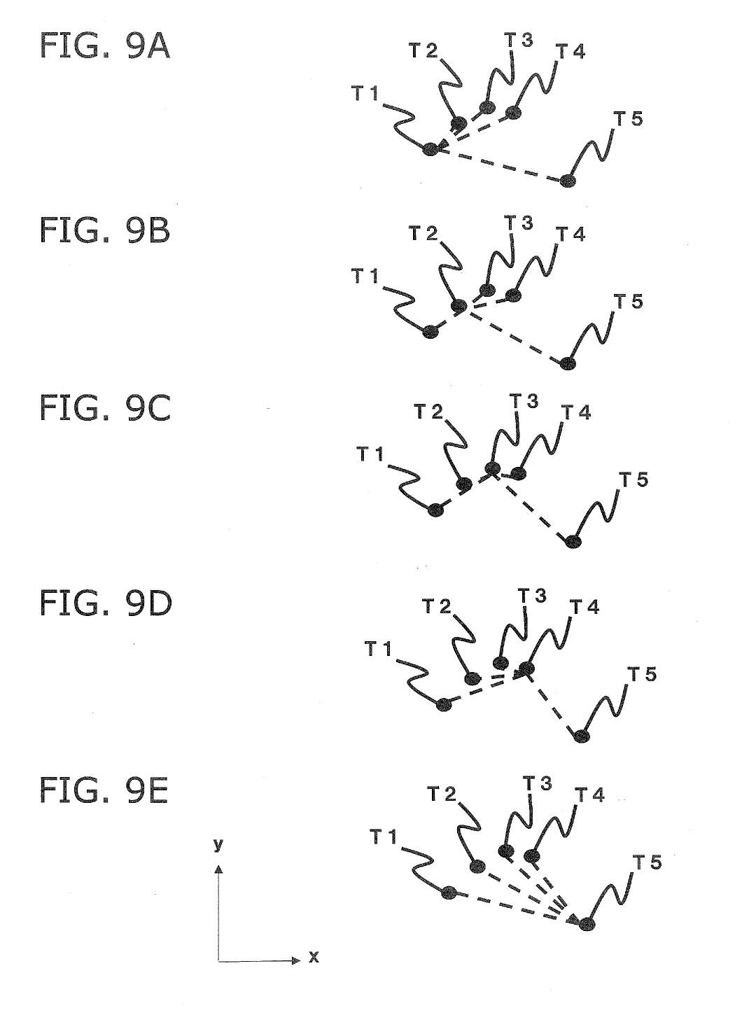

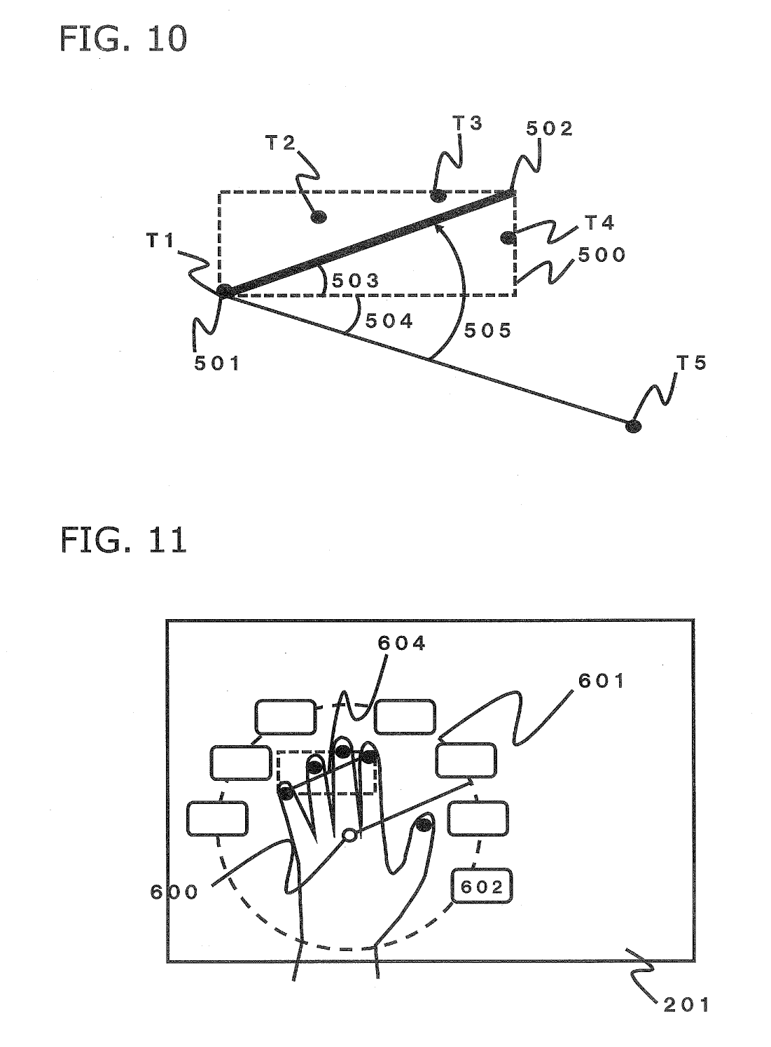

S203: The controller 30 summates all distances between each contact position and the other contact positions. The process of this step is illustrated in FIG. 9A to FIG. 9E. In FIG. 9A, each distance between the contact position T1 (for example, pinky) and each of the other contact positions T2 to T5 is obtained. The distance between two positions can be obtained by Equation 1 as follows, using coordinate values for the contact position T1 and the other contact positions.

AB=\sqrt{(c−a)²+(d−b)²} Equation 1

The Equation 1 calculates a distance between point A (a, b) and point B (c, d), wherein “a”, “c” each represents an X-axis coordinate value and “b”, “d” each represents a Y-axis coordinate value.

The drawing further illustrates distances from the contact position T2 (for example, annular finger) to the other fingers (FIG. 9B), distances from the contact position T3 (for example, mid finger) to the other fingers (FIG. 9C), distances from the contact position T4 (for example, index finger) and the other fingers (FIG. 9D), and distances from the contact position T5 (for example, thumb) and the other fingers (FIG. 9E). Accordingly, the distances from each finger to the other fingers are obtained and summated.

S204: The controller 30 determines whether the calculation in step S203 has been done n times, or whether all distances between each contact position and the other contact positions have been summated.

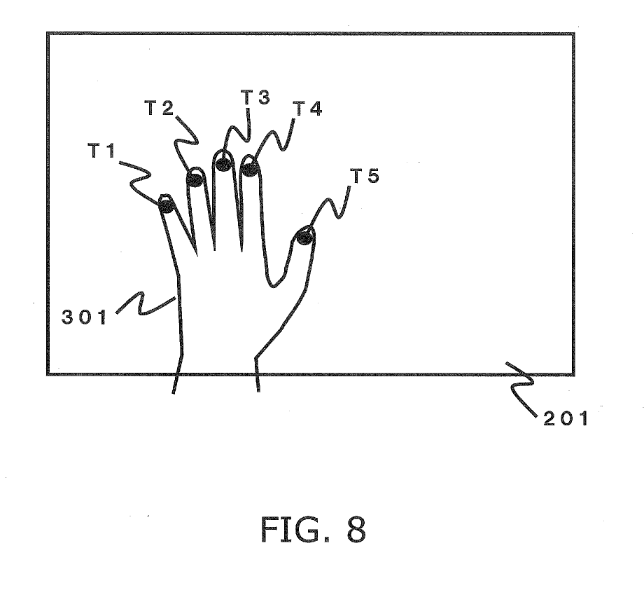

S205: The controller 30 identifies a thumb position among the contact positions T1 through T5, based on the calculation results in step S204. Particularly, the controller 30 compares the summations of distances from each contact position T to the other contact positons, obtained in step S203. Then, the controller 30 determines the contact position with the largest summation to be a thumb position. This embodiment is carried out on the basis that a thumb is located farthest from the other fingers and so the summation of distances between the thumb position and the other finger positions is the largest. The controller 30 therefore determines the contact position having the largest summation of distances to the other contact positions to be a thumb position. In the hand 301 shown in FIG. 8, for example, the position T5 apparently has the largest summation of distances to the other contact positions. Accordingly, the controller 30 determines the contact position T5 to be a thumb position and stores it in the storage 70 as the touch information 73.

Then, the controller 30 determines an angle, size, center coordinate of the hand and whether the touching hand is left or right, based on the contact positions T1 to T4 other than the contact position T5 determined as a thumb contact position. These will be discussed in detail below.

S206: The controller 30 determines an angle of the hand. Specifically, the controller 30 extracts a minimum rectangular region 500 encompassing the coordinates of positions T1 to T4 other than the thumb contact position, as shown in FIG. 10. The rectangular region 500 has a vertex at T1 from which the thumb contact position T5 is farthest. The controller 30 obtains a diagonal line including the lower left point 501 (at T1) of the rectangular region 500, which connects between the point 501 and its upper right point 502. Then, using two coordinate values Δx and Δy, the controller 30 obtains the slope 503 (Δy/Δx). In this embodiment, the slope 503 is determined as a hand angle and stored in the storage 70 as the touch information 73.

The detection of a hand angle is not limited to the above method. Instead, an approximate line connecting coordinates of T1 to T4, excluding the thumb contact position T5, may be obtained as the hand angle.

S207: The controller 30 determines a hand size. Specifically, the controller 30 calculates a distance between the lower left point 501 and the point 502 of the rectangular region 500. The distance between the two points can be obtained by the above Equation 1. The controller 30 stores the calculated distance as a hand size and stores it in the storage 70 as the touch information 73.

S208: The controller 30 further determines a coordinate of a center 600 of the hand, as shown in FIG. 11. Specifically, the controller 30 calculates an average value of the coordinates T1 to T5 as a center positon of the hand and stores it in the storage 70 as the touch information 73.

S209: The controller 30 further determines whether the touching hand is right or left. Specifically, the controller 30 calculates the slope 504 (FIG. 10) using the two coordinate values, which are T5 determined as a thumb contact position and the smallest coordinate (point 501 in this example) among the four other contact positions. The controller 30 then determines whether the hand is left or right based on the slope 503 and the slope 504, as discussed in the following. In this example, the hand 301 shown in FIG. 8 is a left hand. In this case, a slope 505 that is a difference between the slopes 503 and 504 is positive, in other words, the inner product of the vector is positive. This can be determined by the peculiar thumb position of a left hand. The same applies to a right hand, in which case the slope 505 becomes negative due to its peculiar thumb position. In this way, the controller 30 determines whether the hand is left or right and stores the result in the storage 70 as the touch information 73.

Whether the hand is left or right may be determined through comparison between an X coordinate value of the thumb contact position and an X coordinate value of a contact position farthest from the thumb contact position. In this case, the controller 30 may determine that the hand is left if the X coordinate value of the thumb contact position is larger, meaning that the thumb is located on a right side of the other fingers on the screen, and may determine that the hand is right if the X coordinate value of the thumb contact position is smaller, meaning that the thumb is located on a left side of the other fingers on the screen.

Accordingly, the controller 30 calculates coordinates for displaying menus at periphery positions of the hand on the screen 201 as shown in FIG. 7, based on the calculated angle, size, center coordinate of the hand, and determination result on whether the hand is left or right.

S210: The controller 30 obtains a circle 601 having a center 600 in order to output coordinates for the menu positions as shown in FIG. 11. In this example, the controller 30 sets a magnification ratio or adds a fixed value to a radius of the circle 601 so that the circle 601 becomes larger than the calculated hand 604. As a result, the menu coordinates are located around the circumference of the hand. Furthermore, the controller 30 sets the menu coordinates on the circle 601 at positions near the contact positions T1 to T5 and controls the display so that the menu is displayed near a tip of each finger. Still further, since the coordinate value for a thumb position is obtained in this embodiment, it is possible to display a menu preferentially at an easy-to-operate (easy-to-press) position near a thumb, providing an easy-to-use interface for a user. For example, as shown in FIG. 11, the menu 602 is preferentially located and displayed near the thumb position.

The number of the menus and the position (the finger around which a menu is to be displayed, for example) are not limited to those illustrated in the drawings.

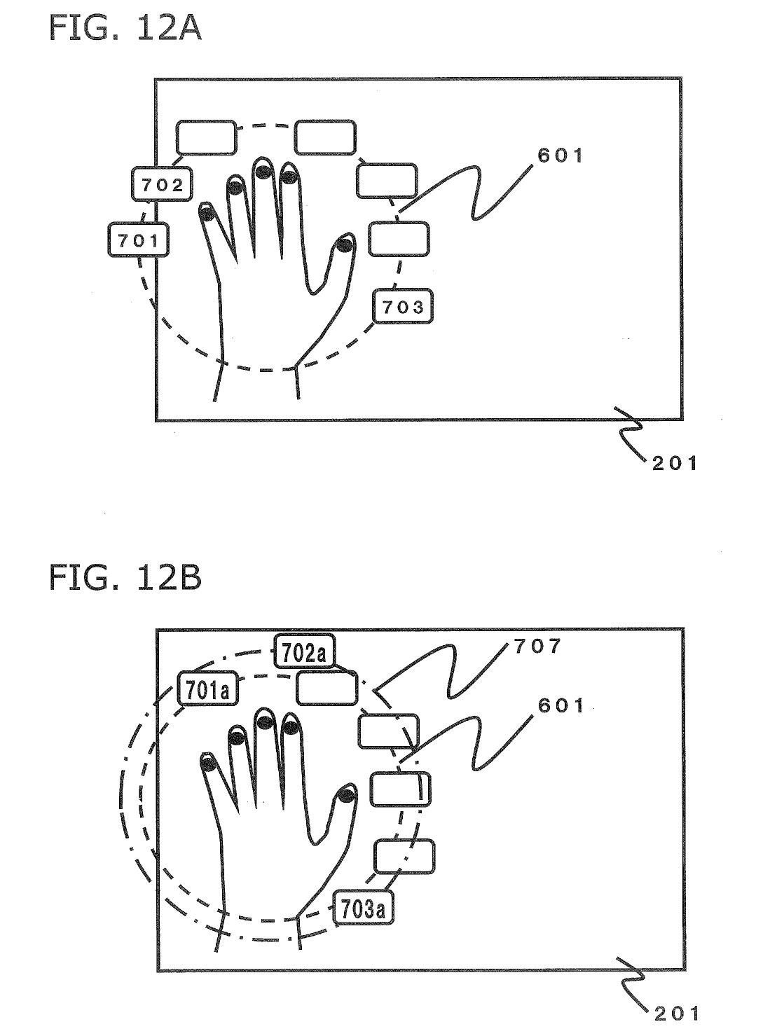

S211: The controller 30 determines whether the menu coordinate is within a display area. Particularly, the controller 30 determines whether the menu display positions are within the screen 201, based on the position of the circle 601 on which the menus are displayed. For example, as shown in FIG. 12A, the circle 601 for displaying the menus is located outside the screen. In this case, the coordinates for the menu display positions cannot be obtained. Accordingly, the controller 30 proceeds to step S212 for correcting the menu coordinate positions, as discussed later. If the menu coordinates are all within the display area, the process goes to step S213.

If the controller 30 determines that the menu coordinates are not within the display area in step S211, it may display an alert on the screen 201 or output an alarm sound via the speaker 80 to inform the user that the menus are not properly displayed. In response, the user may change his/her hand's position on the screen. If the user changes his/her hand's position, or releases his/her hand from the screen, the processing is ended.

S212: The controller 30 corrects the menu coordinates calculated in step S210. As shown in FIG. 12B, the menu coordinates are located on the circle 601, and the controller 30 identifies the thumb contact position. Accordingly, the controller 30 corrects the menu positions by rotating them, for example, toward the thumb position where it is easy for a user to operate (easy to touch the screen). As shown in FIG. 12B, for example, the menu 701 is moved to the position of the menu 701a and the menu 703 is moved to the position of the menu 703a.

If the menu positions are rotated rightward and moved further than the positon of the menu 703a, the menus go under the user's wrist. To avoid this, the controller 30 calculates a menu coordinate circle 707 that is larger than the circle 601 and surrounds the circle 601, and displays the menu 702a on the circle 707 so as not to overlap the other displayed menus.

S213: The controller 30 displays menus on the screen 201 based on the menu coordinates obtained in step S210 or S212, using the graphics controller 33.

S214: The controller 30 determines whether any contact position on the screen 201 has been changed. For example, a user may release one or more of his/her fingers from the screen 201 and touch another position on the screen 201 with that finger. In this case, the process goes back to step S201.

S215: The controller 30 determines whether a touch on the screen 201 has been released. For example, a user may release his/her hand from the screen 201. In this case, the processing is ended.

2-3. Effects, etc.

The tablet computer 1 according to this embodiment (an example of a display device) comprises a display unit 2 (an example of a display unit) including a screen 201 that displays information according to a touch operation, and a controller 30 (an example of a controller) that detects a plurality of contact positions on the screen 201 according to the touch operation and controls the display unit 201 to display a menu (an example of first selection information) at a position spaced from the plurality of contact positions by a predetermined distance. When at least one contact position of the plurality of contact positions is moved in the screen 201, the display unit 201 moves and displays the first selection information on the screen 201 to and at a position spaced from the moved contact position by the predetermined distance.

Accordingly, the screen 201 can display a menu at a position spaced from each corresponding contact position of fingers by a predetermined distance. Therefore, the display interface is easy to operate.

Furthermore, according to the tablet computer 1 in this embodiment, the controller 30 determines a user's thumb contact position and the other fingers' contact positions on the screen 201 based on distances between the plurality of contact positions, and determines a position for displaying a menu on the screen 201 based on the thumb contact position and the other contact positions.

Accordingly, even with a complex change in a hand position or a difference in a hand size, the screen 201 can display a menu at a position in accordance with finger contact positions. Therefore, the display interface is easy to operate.

Still further, the menu is arranged near a user's thumb that is easy for the user to manipulate with, which further makes the display interface easy to use.

In this embodiment, a hand (fingers) can be detected in which not only a palm is detected but also its size, angle, and fingers are detected. Therefore, a graphical user interface (GUI) menu is suitably displayed around a hand, which further makes the display interface easy to use. Furthermore, when a group of five finger touches is detected, it is possible to detect a plurality of hands. This can create an interface using both hands, and enables a menu manipulation by plural users. Therefore, plural users can operate the touch panel at the same time.

2-4. Modified Examples

In this embodiment, when the position for displaying a menu is outside the display area on the screen 201, the menu display position is corrected. In addition to this, the menu display position may be corrected even when it is within the display area in the screen 201.

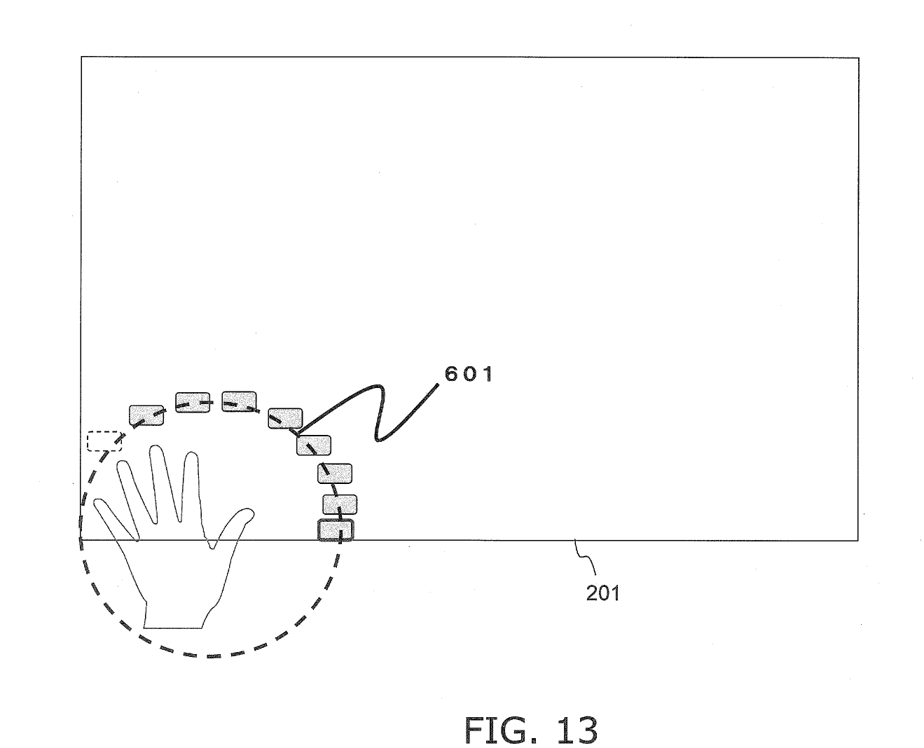

For example, as shown in FIG. 13, when a menu is displayed at a position near a pinky finger, the user has difficulty in selecting the menu, or touching the screen. In this case, the menu position near the pinky finger, which is indicated by a dotted line, may be changed to a position near a thumb.

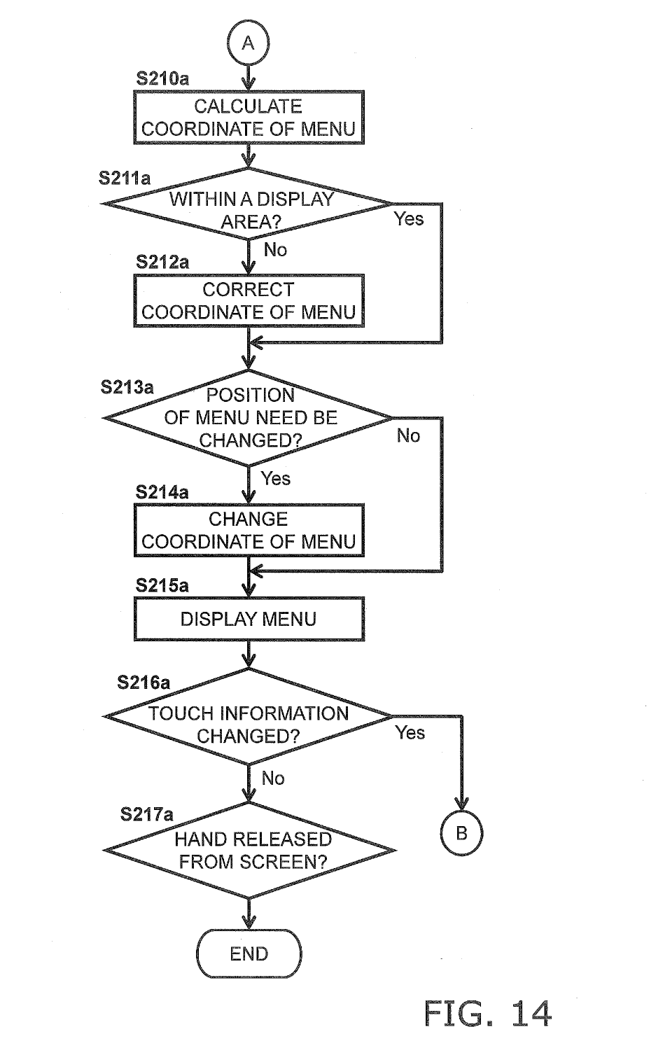

In this example, after the processes from steps S200 to S209 shown in FIG. 6, the controller 30 executes the processes shown in FIG. 14 as substitute for the processes in FIG. 7.

Steps S210a to S212a are the same as steps S211 to S212.

S213a: The controller 30 further determines whether the menu display position need be changed. For example, if the menu coordinate position is away from the coordinate position of a thumb by more than a predetermined distance, it is determined that the menu display position need be changed, and the process goes to step S214a. If the menu display position need not be changed, the process goes to step S215a.

S214a: The controller 30 further changes the menu coordinate that has been calculated in step S210a or has been corrected in step S212a in FIG. 6. As shown in FIG. 13, the controller 30 has obtained the menu coordinate on the circle 601 and the position of the thumb. Accordingly, the controller 30 corrects the menu positions by rotating the menus, for example, toward the thumb or rightwards where the user can easily manipulate the menus or touch the screen. Alternatively, the menu position that is determined to be changed can be moved toward the thumb, or a position near the coordinate of the thumb on the circle 601.

S215a: The controller 30 controls the graphics controller 33 to display the menus on the screen 201, based on the menu coordinates obtained in step S210a, S212a or S214a.

S216a: The controller 30 determines whether any contact position on the screen 201 has been changed. For example, a user may release one or more of his/her fingers from the screen 201 and touch another position on the screen 201 with that finger. In this case, the process goes back to step S201 in FIG. 6.

S217a: The controller 30 determines whether a touch on the screen 201 has been released. For example, a user may release his/her hand from the screen 201. In this case, the processing is ended.

### Other Embodiments

The foregoing descriptions of Embodiments 1 and 2 are provided for illustration of the techniques disclosed in this application. However, the techniques in this disclosure should not be limited to those as disclosed, and various changes, substitution, addition, omission or the like can be made to these embodiments. Each constituent element can be combined with another across Embodiments 1 and 2 to produce another embodied example.

The followings are other embodied examples.

[1]

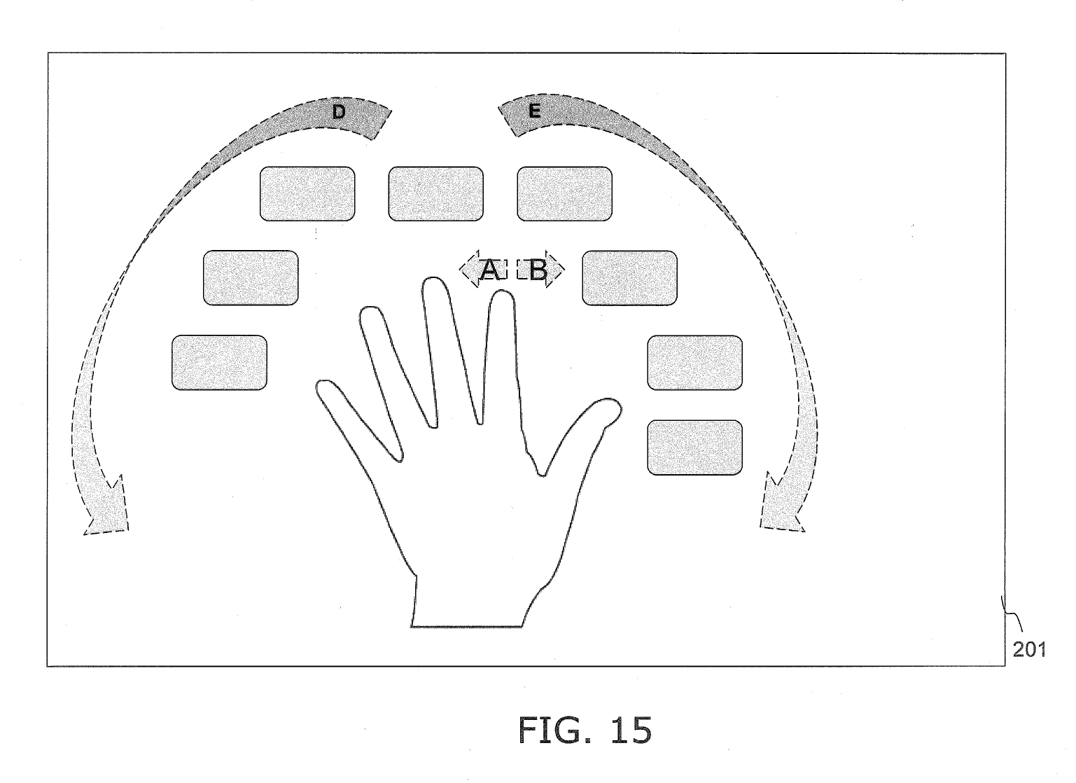

In addition to the correction of a menu position in the above embodiments, each menu item as displayed may be rotated rightward or leftward when a user swipes on the screen with his/her finger (moving a finger across a touch panel), as shown in FIG. 15, for example.

In this case, the controller 30 detects the swipe operation by a user's touch and rotates the menu item coordinate position in the swiping direction by a predetermined amount.

[2]

The menu items are not necessarily embodied by buttons as illustrated in Embodiments 1 and 2.

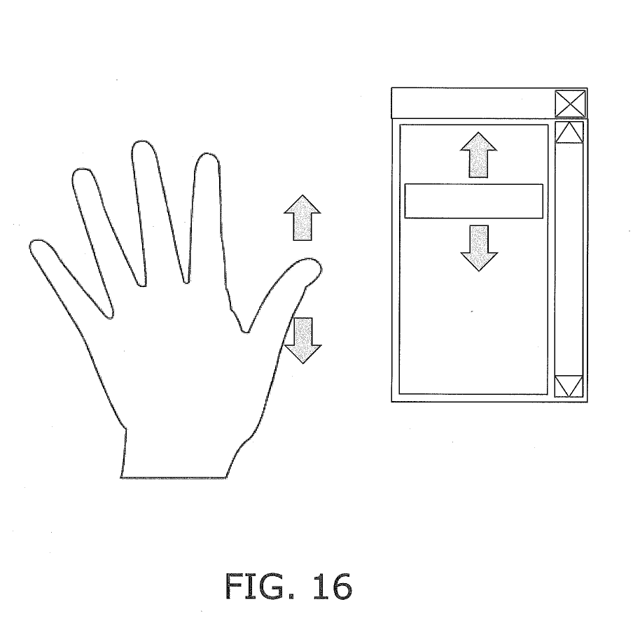

As shown in FIG. 16, for example, the controller 30 may display a list menu or the like on the screen 201. In this case, when a user swipes up and down on the screen by his/her touching thumb, the controller 30 detects the swipe operation and scrolls the displayed list. This enables a user to scroll the menu on the screen by a touch operation, likewise scrolling with a mouse.

[3]

In the above embodiments, menus are displayed on the screen in response to touch operations, but this is not the only option. Other kind of information that a user can select by a touch operation may be displayed.

[4]

In the above embodiments, the display device 1 is a tablet computer including a display panel 2 and a control device 3, but this is not the only option. Another computer device installing a part of the control device 3 may be provided and connected to the display panel 2.

The execution sequences of processes in the above embodiments (as shown in FIG. 6, FIG. 7, FIG. 14, and so on) are not limited to those discussed above, and may be changed without departing from the gist of the invention.

[6]

The present invention is not only embodied by the display device 1, but it may also include a display control method, a computer program implemented by the display device 1, and a computer readable recording medium on which such a program is recorded. The computer readable recording medium may be, for example, a flexible disk, a hard disk, a CD-ROM, an MO, a DVD, a DVD-ROM, a DVD-RAM, a Blu-ray disc, or a semiconductor memory.

The computer program should not be limited to a program recorded on the recording medium, but may be a program transmitted with an electric communication line, a radio or cable communication line, or a network such as the Internet.

The above embodiments are given as examples of the techniques disclosed herein. The accompanying drawings and detailed description thereof are provided only for describing the embodiments.

Accordingly, the constituent elements shown in the accompanying drawings and described in the detailed description may include not only those necessary for solving the technical problems but also those that are not essential for solving the technical problems and only given for illustrating the technique. Therefore, the constituent elements should not be considered as essential elements only because they are shown in the drawings and described in the detailed description.

The foregoing descriptions of the embodiments are provided for illustration only, and therefore, various changes, substitution, addition, omission or the like can be made herein without departing from the scope as defined by the appended claims and their equivalents.

The disclosed technique may be applied to a display device that a user can operate by touching. Particularly, the disclosure can be applied to tablet computers, smartphones, electronic blackboards, etc.

What is claimed:

1. A display device comprising:
a display unit including a screen and a touch panel;
the touch panel configured to sense a touch on the screen; and
a controller configured to detect a plurality of contact positions on the screen where a plurality of touches are made, the controller being configured to control the display unit based on the detected plurality of contact positions,
wherein the display unit is configured to display first selection information at a first information position on the screen, the first information position being spaced from the plurality of contact positions by a predetermined distance, and
when at least one contact position of the plurality of contact positions is changed, the display unit changes the first information position so as to maintain the predetermined distance between the first selection information and the at least one contact position on the screen.

2. The display device according to claim 1, wherein the display unit is configured to display second selection information when an item of the first selection information has been selected, the second selection information varying depending on the selected item of the first selection information.

3. The display device according to claim 2, wherein the display unit is configured to display the second selection information at a second information position on the screen, the second information position corresponding to a contact position different from other contact positions of the plurality of contact positions corresponding to the first selection information.

4. The display device according to claim 2, wherein the display unit is configured to stop displaying the first selection information when displaying the second selection information.

5. The display device according to claim 1, wherein the display unit is configured to display two or more items of the first selection information corresponding to two or more contact positions of the plurality of contact positions, respectively.

6. The display device according to claim 5, wherein the two or more items of the first selection information are identical with each other, and
the display unit is configured to stop displaying one of the two or more items of the first selection information when another one of the two or more items of the first selection information has been selected.

7. The display device according to claim 1, wherein the display unit is configured to display the first selection information so as to be disposed along at least part of a circle that encompasses a hand of a user placed on the screen.

8. The display device according to claim 7, wherein the display unit is configured to change the first information position by moving the first information position in a rotation direction of the circle on the screen in response to a touch operation performed by the user.

9. The display device according to claim 1, wherein the controller is configured to:
determine a first contact position and two or more second contact positions among the plurality of contact positions based on a distance between the plurality of contact positions, the first contact position corresponding to a thumb position of a user touching the screen, the two or more second contact positions corresponding to finger positions of the user other than the thumb position; and
determine a first selection information display position to display the first selection information based on the first contact position and the two or more second contact positions.

10. The display device according to claim 9, wherein the controller is configured to have the display unit display the first selection information at two or more first information positions, the two or more first information positions including a position corresponding to the first contact position and a position corresponding to at least one second contact position closer to the first contact position among the two or more contact positions.

11. The display device according to claim 9, wherein the controller is configured to:
determine whether a user hand touching the screen is a left hand or a right hand, based on the first contact position, the two or more second contact positions, and a positional relation between the first contact position and the two or more second contact positions; and
determine the first selection information display position based on a determination result on the user hand.

12. The display device according to claim 9, wherein the controller is configured to:
estimate a size of the user hand touching the screen, based on a positional relation between the two or more second contact positions; and
determine the first selection information display position based on the estimated size of the user hand.

13. The display device according to claim 9, wherein the controller is configured to:
detect a center of the user hand touching the screen, based on the first contact position and the two or more second contact positions; and
determine the first selection information display position to be a position along a circle centered at the detected center of the user hand.

14. The display device according to claim 1, wherein the controller is configured to:
determine whether the first selection information display position is within a display area on the screen; and
change the first selection information display position so as to be within the display area when determining that the first selection information display position is outside the display area.

15. The display device according to claim 13, wherein the controller is configured to change the first selection information display position by rotating the first selection information display position toward the display area along the circle, when determining that the first selection information display position is outside the display area.

16. The display device according to claim 9, wherein the controller is configured to:
determine whether the first selection information display position is more than a specific distance away from the first contact position; and
change the first selection information display position to a position corresponding to a second contact position of the two or more second contact positions that is closer to the first contact position, when determining the first selection information display position is more than the specific distance away from the first contact position.

17. A display control method using a display device including a screen and a touch panel, comprising:
detecting a plurality of contact positions on the screen where a plurality of touches are made;
displaying on the screen first selection information at a first information position on the screen, the first information position being spaced from the plurality of contact positions by a predetermined distance; and
when at least one contact position of the plurality of contact positions is changed, changing the first information position so as to maintain the predetermined distance between the first selection information and the at least one contact position on the screen.
